(19) United States
(12) Patent Application Publication
(10) Pub. No.: US 2003/0129969 A1
(43) Pub. Date: Jul. 10, 2003

(54) Messaging system, apparatus and methods

(76) Inventor: David B. Rucinski, Red Bank, NJ (US)

Correspondence Address: MOSER, PATTERSON & SHERIDAN L.L.P., 595 SHREWSBURY AVE, FIRST FLOOR, SHREWSBURY, NJ, 07702, US

(21) Appl. No.: 10/224,213

(22) Filed: Aug. 20, 2002

Related U.S. Application Data
(60) Provisional application No. 60/346,479, filed on Jan. 7, 2002.

(51) Int. Cl. H04M 11/10

(52) U.S. Cl. 455/412; 455/414

(57) ABSTRACT

A system method and apparatus in which a computing device able to access an instant messaging service provides access to such IM service to at least one wireless device, the computer operates to process messages between the instant messaging service and wireless device(s) by converting a protocol associated with the instant messaging service to a light protocol adapted for use by the wireless device(s).

### CROSS-REFERENCE TO RELATED APPLICATIONS

This application claims benefit of U.S. provisional patent application serial No. 60/346,479, filed Jan. 7, 2002, which is herein incorporated by reference in its entirety.

This patent application is related to simultaneously filed U.S. patent application Ser. No. ______ (Attorney docket ELIT/004) entitled REDUCED COMPLEXITY USER INTERFACE, which is incorporated herein by reference in its etirety.

### TECHNICAL FIELD

The invention relates to the field of communication systems and, more specifically, to wireless access to “instant” or substantially contemporaneous messaging systems.

### BACKGROUND OF THE INVENTION

Instant messaging systems such as those provided by American On Line (AOL), Microsoft and ICQ are known. These messaging systems allow defined groups such as “buddy lists” (within the AOL system) to be quickly notified of the accessibility of any members when such member connects to the Internet using their computer. Active or connected members of a group may then exchange information, such as text, files and the like.

Unfortunately, present means for accessing instant messaging systems are bulky and inflexible (for example, personal computers) or expensive (for example cellular telephones).

### SUMMARY OF THE INVENTION

A method according to one embodiment of the invention comprises converting a received instant messaging (IM) service message into an intermediate protocol message; and transmitting said intermediate protocol message using a radio frequency (RF) transport protocol, the RF transport protocol adapted for use by at least one wireless device.

An instant messaging system according to an embodiment of the invention comprises at least one wireless device capable of sending and receiving messages using an intermediate messaging protocol; and a computing device, for enabling message communication between the wireless device and an instant messenger service, the computing device translating messages between the intermediate messaging protocol and a protocol adapted for use by the instant messenger service.

These and other deficiencies of the prior art are addressed by the present invention of systems, methods and apparatus in which a base station in wireless communication with one or more mobile or handheld devices receives text messages from the devices and delivers text messages to the devices within the context of an instant messenger service.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system according to an embodiment of the invention;

FIG. 2 depicts a high-level block diagram of a controller suitable for use in the system of FIG. 1;

FIG. 3 depicts a flow diagram for receiving an instant messaging service message;

FIG. 4 depicts a flow diagram for transmitting a message to an instant messaging service;

FIG. 5 graphically depicts an architecture adapted to the present invention; and

FIG. 6 graphically depicts a light protocol data structure suitable for use in the present invention.

To facilitate understanding, identical reference numerals have been used, where possible, to designate identical elements that are common to the figures.

### DETAILED DESCRIPTION OF THE INVENTION

The subject invention will be primarily described within the context of a system in which a base station working in conjunction with a computer accesses an instant messaging service via the Internet. The base station communicates in a wireless manner to one or more wireless devices having respective users to enable the communication of instant messages between each of the one or more wireless devices and the instant messaging service. The base station cooperates with a computing device that is communicating with the Internet or other network. Text messages may be passed between devices via the base station alone, where the sending and receiving device communicates with the same base station. Text messages may also be passed via the Internet, where the communicating and receiving devices cooperate with different base stations. In another embodiment of the invention, all text messages are communicated to a central messaging server via the Internet and propagated to a receiving device via the Internet. However, it will be appreciated by those skilled in the art that the subject invention has broad applicability to any messaging system in which protocol translations may be utilized to reduce cost and complexity of a messaging device.

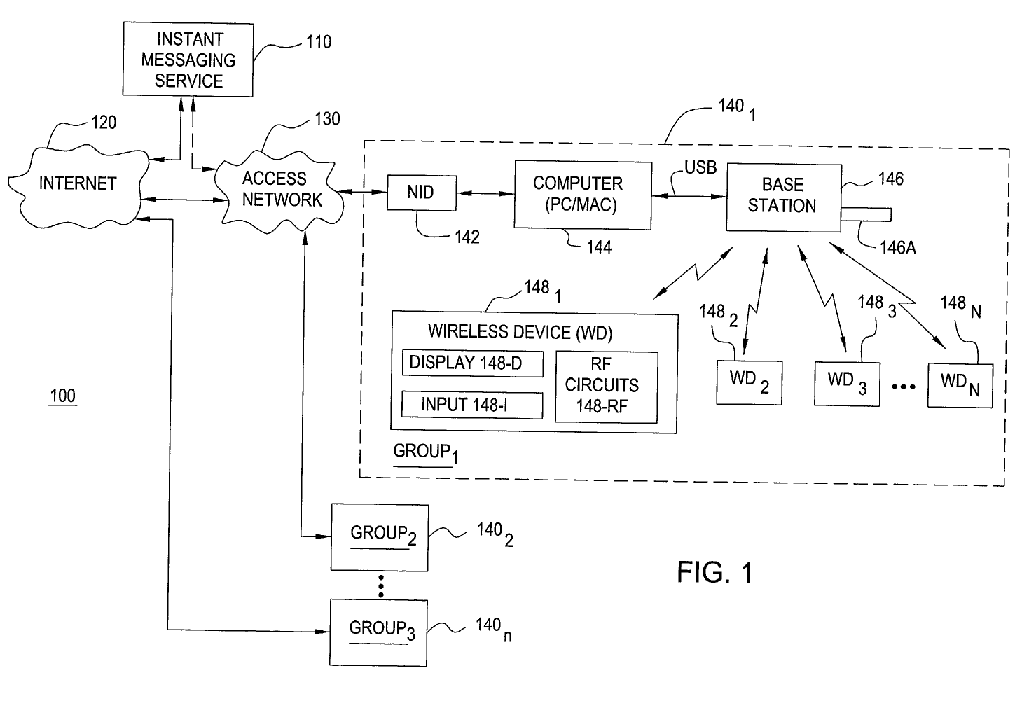

FIG. 1 depicts a high-level block diagram of a system according to an embodiment of the invention. Specifically, the system 100 of FIG. 1 comprises an instant messaging service (IMS) 110 that communicates with IMS subscribers via the Internet 120 and/or an access network 130 associated with the subscribers.

The access network 130 may comprise, illustratively, an Internet service provider (ISP) utilizing dialup, cable modem, digital subscriber line (DSL), satellite access and the like. Typically, an access network is used to provide access to the Internet for a respective plurality of ISP customers. Some of these customers may also be instant messenger service subscribers. It is noted that a plurality of access networks may be employed by respective ISP customers to connect to the Internet, though only a single access network 130 is shown in FIG. 1.

Each of a plurality of groups 140₁ through 140_{N} (collectively groups 140) comprises one or more wireless devices 148 in communication with a respective base station 146. Each base station 146 communicates with a computing device 144, such as a personal computer (PC), Macintosh or Linux system via, illustratively, a universal serial bus (USB) or other communications link. The computing device may also comprise a personal digital assistant (PDA) or other device using a Palm, WindowsCE, VxWorks or other operating environment. The computer 144 includes client software the implements some of the methods of the present invention (e.g., a PC client implementing the various functions described in the below flow diagrams). The computer 144 communicates with a network interface device (NID) 142, which in turn communicates with the Internet 120 directly or via the access network 130. The network interface device (NID) 142 comprises a modem compatible with the access network 130 (e.g., a DOCSIS modem in the case of a cable television access network, a dialup modem in the case of a plain old telephone system (POTS) access network and the like).

The base station 146 may be an integral part of the computer 144 or may be a separate device connected to the computer. For example, the base station may comprise a card or other device inserted into a slot and sharing or communicating with computing resources via the computer system bus. Alternatively, the base station may comprise a separate device connected to the computer by a universal serial bus (USB) or other serial interface, a parallel interface or a network connection (e.g., Bluetooth or Ethernet). In the below description of the invention, the terms computer, base station and wireless device should be broadly construed to mean, respectively, computing function, base station function and wireless device function. These functions may be combined as described herein.

The radio frequency (RF) protocol is designed to permit wireless device to base station communications for multiple wireless devices or handsets. The RF protocol uses, preferably, time-domain signaling with the base station acting as a master to synchronize responses from individual wireless devices. Frequency domain signaling may also be used, though at present time-domain signaling is less expensive. Various wireless technologies such as wideband, ODFM, bluetooth, 802.11 and the like may also be employed within the context of the present invention. In addition, custom RF protocols and techniques may be used, such as frequency hopping and/or spread spectrum.

Each of a plurality of wireless devices 148₁ through 148_{N} (collectively wireless devices 148) are shown in FIG. 1 as part of a first group 140₁. The inventors envision that in one embodiment, each group represents a household such that an existing computer within the household may have attached to it a base station that wirelessly cooperates with at least one wireless device to enable instant messaging capability for each wireless device within the group. In this manner, the wireless devices within the group may communicate with each other and with other subscribers to the instant messaging service as long as such devices are within the range of a base station allowing access. It will be appreciated by those skilled in the art that each of the groups 140 may have associated with it one respective wireless device 148 or many respective wireless devices 148. Additionally, in some embodiments of the invention, a wireless device 148 may be associated with a plurality of groups. That is, a wireless device 148 may be in communication with a base station 146 from each of a plurality of groups either simultaneously or sequentially.

Each of the wireless devices 148 includes an output means 148-D such as a display device (e.g., a liquid crystal display (LCD) or other display device), an input device 148-I such as a keypad or touch screen, and various radio frequency (RF) circuits 148-RF including RF appropriate chip sets, antenna and the like adapted for communication with the base station 146. The input means and display means enable a user to, respectively, input message or command data and display input or received message and command data. The user may enter text into the device by holding the device in two hands and performing “thumb typing;” by placing the device on a table and using a two-finger “poke typing” technique or by holding the device with one hand and “poke typing” with the other hand. Preferably, the wireless device includes an angled keyboard and display surface enabling easy viewing and typing, hand grips on each side of the device for one or two hand comfort when holding the device, and contours underneath the device to improve user grip of the device.

Optionally, each of the mobile computing devices includes an alerting means (e.g., sound or light generation means) for alerting a user that a message has been received, that a connection or registration has been made, or other functions have been achieved, such as discussed elsewhere within this application. In one embodiment, alerts are generated using the RTX file format (which is used to specify ring tones in some cellular telephones).

It will be appreciated by those skilled in the art that different physical layers may be utilized to effect communication between the computing device and base stations, and to effect communication between the base stations and respective mobile computing devices. Moreover, the mobile computing devices may comprise devices such as discussed herein, mobile telephones, personal digital systems (PDAs) and the like.

Prior to use, several initialization and registration routines are performed in the system 100 of FIG. 1. For example, in one embodiment, the first time a wireless device is powered up the device performs a scanning function to determine which base station(s) are in RF proximity to the wireless device. If one base station is detected, then the communication path is established between a wireless device and the computing device associated with the base station such that an initial registration process may be performed. That is, various identifiers are exchanged between the wireless device, computer and, optionally, base station such that subsequent communication sessions between the devices may be supported. In the case of the detection of multiple base stations, the user may be prompted to select which of the base stations is to be used or, optionally, the base station emitting the strongest RF signal is selected.

As part of the registration process, the user enters information into the wireless device or computing device such that the application software running within the computing device is informed as to the instant messaging service or services to which the user subscribes, the log in and/or password information associated with the user subscription, the “buddy lists” or other groups of instant messaging system subscribers that are to be informed of each other's active presence with the instant messaging service. Multiple buddy lists may be utilized such as friends, co-workers, family members and the like. Additionally, multiple services may be used, such as AOL, MSN, Yahoo and the like. Instant messaging chat sessions operate, from the perspective of the user, in the same manner as if the user was sitting at his computer.

All translations of protocols and the like are handled by software operating within the computing device or, optionally, the base station. Users may log off, chat, hide, set alerts and the like in accordance with the standard functions offered by the various instant messaging services. The wireless device 148 is also responsive to a series of error messages to help guide a user in establishing, conducting and/or terminating an instant messaging session. Additional user help may be provided via the display of the wireless device to set wireless device functions, base station functions and application software functions.

Software executing on the computing device 144 performs protocol and translation functions such that existing instant messaging services may be utilized by operators of the wireless handheld devices. In one embodiment, the wireless handheld devices may be registered for use with a plurality of base stations, such that a coverage area within which the registered wireless handheld device is active can be greatly increased. The process of registration comprises establishing a communication link between a base station and a handheld device. The establishment of such communication may be automatic (e.g., each base station responds to each handheld device within its range) or controlled (a base station selectively responds to devices requiring registration). Security protocols are preferably utilized wherein registration only of a predefined subset of mobile devices is allowed for each base station (i.e., those identified as part of a “family” of devices during an initial programming of the base station).

In one embodiment of the invention, secure communication between the base stations and a plurality of wireless devices is effected within a predefined range, such as 150 feet. This range may be increased or decreased.

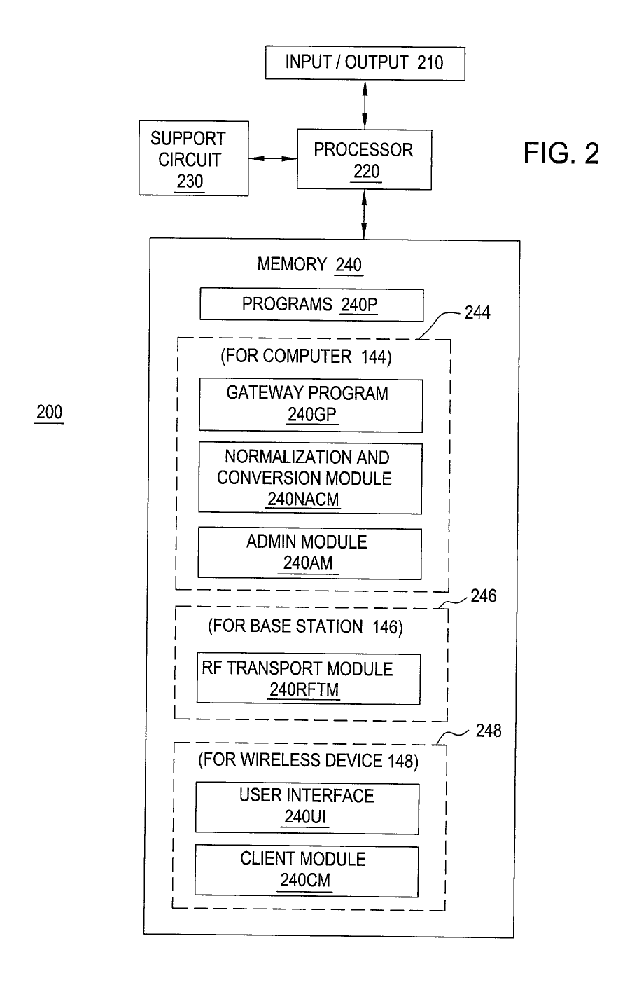

FIG. 2 depicts a high-level block diagram of a controller suitable for use in the system 100 of FIG. 1. Specifically, the controller 200 of FIG. 2 comprises a processor 220 as well as memory 240 for storing various programs 240P. The processor 220 cooperates with conventional support circuitry 230 such as power supplies, clock circuits, cache memory and the like as well as circuits that assist in executing the software routines stored in the memory 240. As such, it is contemplated that some of the process steps discussed herein as software processes may be implemented within hardware, for example as circuitry that cooperates with the processor 220 to perform various steps.

The controller 200 also contains input/output (I/O) circuitry 210 that forms an interface between the various functional elements communicating with the controller 150. For example, if the controller 200 is used to implement the computer function 144 in the system 100 of FIG. 1, the I/O circuitry 210 is used to facilitate communications between the computer 144 and each of the network interface device 142 and base station 146. If the controller 200 of FIG. 2 is used to implement the base station function 146 in the system 100 of FIG. 1, the I/O circuitry 210 is used to facilitate communication between the base station 146 and each of the computer 144 and any wireless devices 148. In the case of wireless communications, an antenna (not shown) is used to facilitate such communications with the base station.

The architecture of the controller 200 of FIG. 2 may be replicated and used to implement each of the various functions discussed above with respect to the system 100 of FIG. 1; namely, the instant messenger service function 110, the network interface device function 142, the computer function 144, the base station function 146 and the wireless device function 148.

The memory 240 is depicted as optionally including a set of software modules 244 intended for use in the computer 144, a set of software modules 246 intended for use in the base station 146 and a set of software modules 248 intended for use in the wireless device 148. It is noted that the particular software modules actually stored in memory are adapted in response to the particular function implemented using a version of the controller 200 of FIG. 2.

The controller 200 when used to implement the computer function 144 includes within memory 240 various programs 244 associated with the computer function. For example, a gateway program 240GP is used to bi-directionally convert the specific protocol messages for each service to a simple or reduced set of commands and data structures. That is, for each instant messaging service, a specific gateway program module adapts service specific protocol data structures into a reduced or simple set of commands and data structures. Similarly, a normalization and conversion module 240NACM converts the different service-specific gateway commands and data structures to a single common set of interface commands and data structures. This common set of interface commands and data structures may be implemented as an intermediate protocol or light protocol, such as discussed below with respect to FIG. 6. In this manner, the operation of a wireless device 148 is simplified since the wireless device need only process data according to a single language or format. A conversion element of the normalization and conversion module 240NACM formats commands and data structures provided by the normalizing module to and from the lightweight protocol for transport over the RF link between the base station and the wireless device(s).

An administration module 240AM permits users to administer optional preferences. Such preferences may include, for example network interface options, message alert melodies, or parental controls for message types that may be received that may be modified by a user via a command sent to the base station. Some administration options impact the behavior of the normalizing and conversion model. Others control the network interfaces.

The normalizing and conversation module 240NACM operates to convert dissimilar messaging protocols to a common interface and then translates the common interface elements into a lightweight or intermediate protocol.

Although the controller 200 of FIG. 2 is depicted as a general-purpose computer that is programmed to perform various control functions in accordance with the present invention and disclosure herein, the invention can be implemented in hardware as, for example, an application specific integrated circuit (ASIC). As such, the process steps described herein are intended to be broadly interpreted as being equivalently performed by software, hardware or a combination thereof.

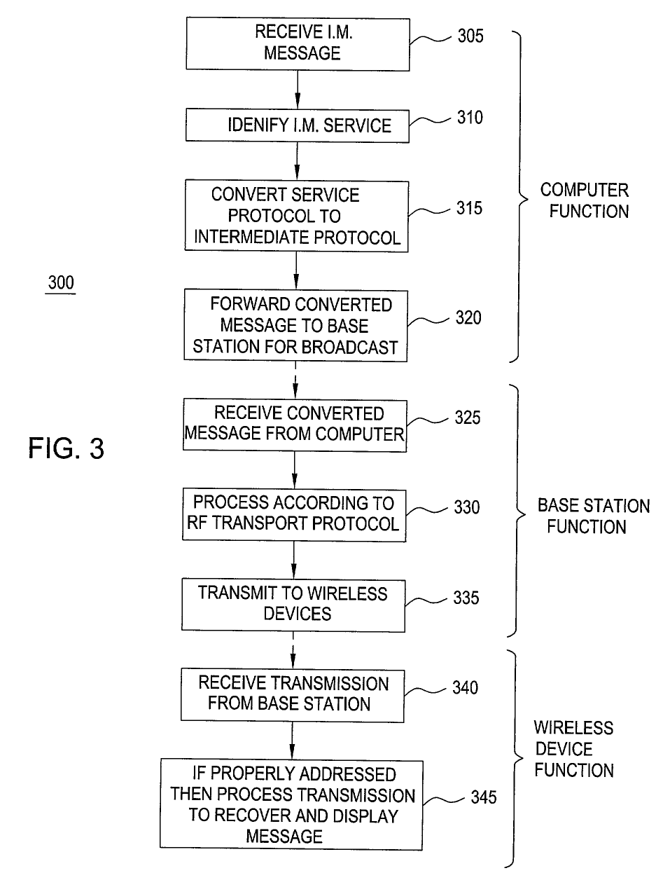

FIG. 3 depicts a flow diagram for receiving an instant messaging service message. Specifically, the method 300 of FIG. 3 is entered at step 305, when an instant messenger (IM) message is received by the computer 144. At step 310, the computer identifies the specific instant messenger service used (e.g., Microsoft Messenger, AOL Instant Messenger, ICQ and the like). At step 315, the computer converts the protocol or data structure associated with the received IM message to an intermediate protocol or data structure, such as the light protocol data structure 600 discussed below with respect to FIG. 6. Briefly, the intermediate or light protocol utilized within the present invention comprises a reduced complexity protocol that is well suited for use in a wireless device having a limited processing capability. Advantageously, the use of an intermediate or light protocol enables a wireless device 148 to subscribe to multiple instant messaging services without modifying software resident within the wireless device.

At step 320, the converted message is forwarded to the base station for subsequent broadcast to the wireless device(s).

At step 325, the base station receives the converted message (i.e., the intermediate or light protocol message) forwarded from the computer. At step 330, the forwarded light protocol message is processed according to a radio frequency (RF) transport protocol adapted for use in communicating with the wireless devices 148. In one embodiment of the invention, an exemplary protocol comprises a For example, a suitable RF protocol comprises a ping-pong time-domain protocol having time-slots allocated for multiple handsets. Other protocols such as discussed above may also be used. At step 335, the RF transport protocol process message is transmitted to the wireless device(s).

At step 340, one or more wireless devices 148 associated with the base station 146 receives the transmitted message provided by the base station. At step 345, if the transmitted message is properly addressed (i.e., the address of the receiving wireless device matches the address associated with the IM message), then the wireless device(s) processes the transmission to recover and display any message.

The above-described method 300 of FIG. 3 combines exemplary functions of the computer 144 (i.e., steps 305-320), the functions of the base station 146 (i.e., steps 325-335) and the functions of the wireless device 148 (i.e., steps 340-345) to present an embodiment of those steps associated with the reception of a message from an Internet messaging service within the context of the present invention.

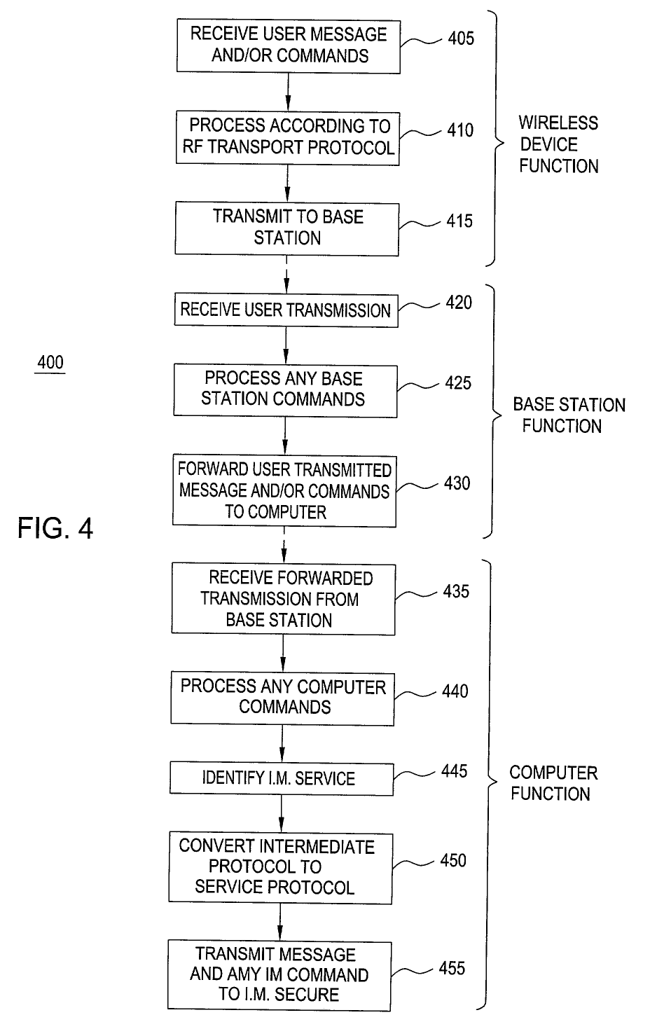

FIG. 4 depicts a high-level block diagram of a method for transmitting a message according to an embodiment of the present invention. Specifically, the method 400 is entered at step 405, when a wireless device receives a user message and/or command via, for example, a keyboard entry interaction from a user. At step 410, the entered message and/or command is processed according to an RF transport protocol adapted for use in communicating between the wireless device 148 and base station 146. At step 415, the processed messages and/or commands are transmitted to the base station 146.

At step 420, the base station 146 receives the user transmission and extracts therefrom the transmitted message and/or commands. At step 425, the base station processes any commands that are adapted to modify base station operation or otherwise are appropriate to be processed by the base station. At step 430, the message and/or commands received by the base station are forwarded to the computer 144.

At step 435, the computer 144 receives the message and/or commands forwarded from the base station. At step 440, the computer processes any commands that are adapted to modify operation of the computer or otherwise appropriate to be processed by the computer. At step 445, the method identifies which instant messaging service is associated with the user and, more particularly, which instant messaging service is associated with the particular message and/or commands transmitted by the user via the wireless device. At step 450, the message and/or commands provided by the user are converted from the intermediate or light protocol used by the wireless device and base station to the service protocol appropriate to the identified instant messaging service. At step 455, the computer transmits the user message and any instant messaging commands to the instant messaging service.

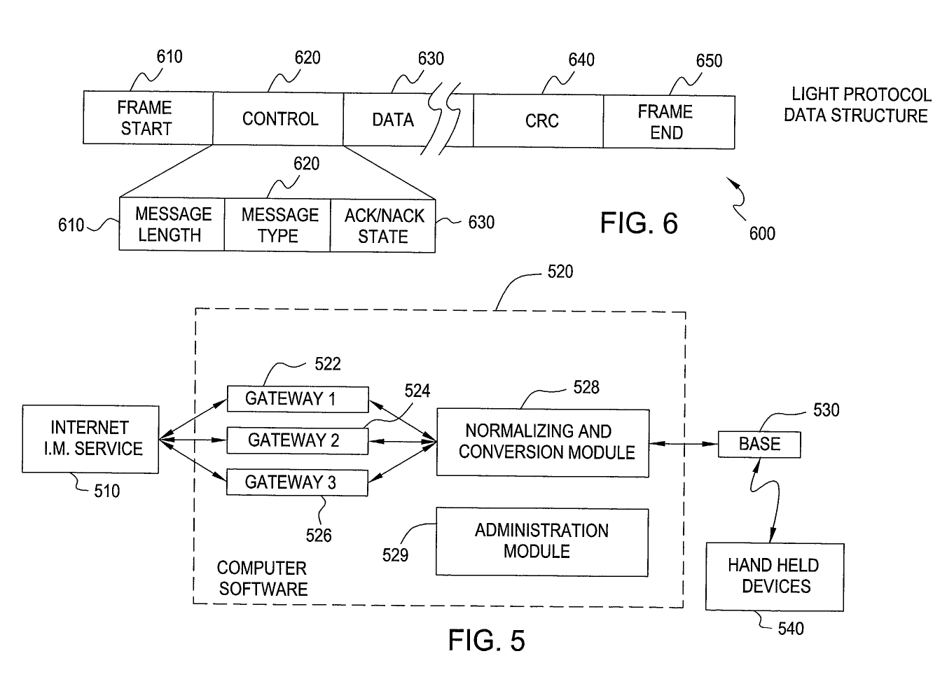

FIG. 5 graphically depicts an architecture adapted to the present invention. Specifically, FIG. 5 depicts hardware and software functions and functional interface points providing an architecture suitable for use in the present invention. The architecture 500 of FIG. 5 contemplates an Internet instant messaging (IM) service 510 that communicates with software 520 resident on a computing device 144. The software comprises a plurality of gateway modules, illustratively three (522, 524 and 526), where each gateway module is adapted to process information associated with a respective instant messaging service (e.g., Microsoft Messenger, AOL Instant Messenger, Yahoo Messenger, ICQ etc.). A normalizing and conversion module 528 cooperates with each of the gateway 522-526 to normalize and convert message and protocol formats between a service-specific format provided via and to the gateways and an intermediate or light protocol format provided to handheld devices 540 via a base station 530. An administration module 529 performs various housekeeping and processing functions (e.g., keeping track of link layer/physical layer processes and the like). The various functions of the architecture 500 of FIG. 5 are described above with respect to FIGS. 2-4.

FIG. 6 graphically depicts a light protocol data structure suitable for use in the present invention. Specifically, the data structure 600 of FIG. 6 comprises a frame start field 610, a control field 620, a data field 630, a circular redundancy check (CRC) field 640 and a frame end field 650. The control field 620 may include a message length field 622, a message type field 624 and an ACK/NACK state field 626. In one embodiment, only a frame start field is used (i.e., no frame end field is used).

The lightweight protocol is optimized to enable the use of a low-powered processor having a small memory footprint in the wireless device 148. The lightweight protocol preferably adheres to the following characteristics (though not all of these characteristics are necessary): (1) a character-only (i.e., no-bit) level encoding/decoding of data; (2) reserved characters for frame delineation; (3) numeric chat window identifiers to minimize parsing through ASCII lists; (4) simple message decoding and encoding with simple position-based parsing of message and text data; (5) simple debugging with text-only protocol monitors; (6) low bandwidth requirements such that multiple wireless devices or handsets are supported and low-cost transmission/reception components for wireless communications between the base and wireless devices may be used; (7) simplified conversion of information from the user interface to the lightweight or intermediate protocol message structure; and (8) the logical mapping of messages to the user interface such that the need to store state information in the wireless device is eliminated, thereby simplifying the design and cost of the wireless device 148.

In exemplary embodiments, the data structure is an 8-bit character-oriented protocol in which the smallest size data arriving from (or being sent to) the link layer (i.e., the software within the wireless device communicating with corresponding base station software to effect an RF link protocol) is one 8-bit character in size. Those skilled in the art will recognize that other sizes both larger and smaller may be utilized.

The frame start field 610 and frame end field 650 contain a unique character (e.g., 0 ffh) to indicate the respective start and end of a frame. The frame start 610 and frame end 650 character may be the same or may be different.

Within the control field 620, the message length field 622 indicates the amount of data within data field 630, the message type field 624 indicates the type of message included within the data field and the ACK/NACK state field 626 indicates that a last message was successfully received from the far end (ACK) or that a CRC or other error exists with respect to the last message received (NACK).

The data field 630 is where the content of a message is contained. While the data field 630 nominally contains text data, it may also contain characters representing special non-text characters such as emoticons (i.e., characters or symbols intended to convey an emotion typically associated with a message, such as a “smiley face”).

The circular redundancy check (CRC) FIELD 640 contains, illustratively, an 8-bit CRC character. The CRC field 640 may use more or fewer bits, depending upon the error characteristics of the RF channel used to communicate between the wireless device and the base station. In one embodiment of the invention, the CRC field cannot have a value equal to 0 ffh, since this value is reserved for use as a frame start/frame end indicator. In the case of a sending device computing a CRC value of 0 ffh, another value such as 0 feh is substituted and sent instead. On the receiving end, a CRC value of 0 feh is considered a match with a computer value of either 0 feh or 0 ffh. Many modifications of the above will be readily apparent to those skilled in the art informed by the teachings of the present invention.

In one embodiment, the control field is 2 characters long. The first character indicates the length of the data field of the message, which is selected to be between 0 and 254. since all of the other message fields are of fixed size the total message size can be determined from this information. The second character is split into three elements of information. The lower five bits of the second character is the Message Type, from 0-31. The upper 2 bits, which can range in value from only 0-3 is for transmission of an ACK, NACK, or other signaling indications. Bit 5 is used to hold the sequence number of the message and it contains a value of 0 or 1. It is used to detect when the protocol sends duplicate messages under some error scenarios. The transmitter (base station or wireless device) toggles this value when a new message is sent. If a retransmission is sent, the value should remain the same. The receiver should check to see that this value toggles on each message. Receipt of two messages without a change in the state of this bit indicates a duplicate message (since we have a window size of one, only one bit is needed to check for duplicates).

A registration process is optionally used to authenticate the instant messaging user operating a wireless device. To register a wireless device, the device sends a registration request to the PC client with the data field 630 containing the log-in name and password of the user. These are preferably identical to the log-in and password that the client uses to log in to the desired instant messaging service, though different log-in/password combinations may be used. The PC client then attempts to log into the instant messaging service using the provided log-in name and password. If successful, the PC client returns a “registration granted” message and instant messaging operation may continue. If unsuccessful, the PC client returns a “registration rejected” message such that a user must reenter their log-in name and password, since one or both may not be valid.

In one embodiment of the invention, some or all of the following ten alerts are provided: power on and awake from sleep mode; new message arrived; buddy arrived (played when buddy list entry comes on line); buddy left (played when buddy list entry goes off line); send (played when message is sent with entered key); service disconnected; service connected; out of range (unable to communicate with base station); returned to in-range (communication with base station reestablished); and enter sleep mode (wireless device enters reduced power mode after inactivity for a predetermined period of time, such as ten minutes. During sleep mode or reduced power mode, the wireless device may periodically energize itself and determine if new messages have been received or new alerts have been received.

It is contemplated by the inventor that the disclosed systems, methods and apparatus may find particular applicability within the context of a cost-sensitive setting such as a residential setting. That is, the disclosed protocols advantageously provide operational constraints (such as the required ordering of data, placement of data flags and the like) such that a simplified hardware design is enabled (i.e., less pausing to find data packets/frames). In this manner, complexity is moved away from local devices and towards the client software executing on the computing device or, alternatively, the base stations. It is also contemplated that more expensive or fully featured devices may include circuitry and software or firmware compatible with the disclosed protocols and communications techniques such that many different types of devices may operate within the systems of the present invention. For example, where particular industrial designs are disclosed which are limited in functionality to only that which is necessary to support communications using the inventive system, other devices having more robust functionality may also be used within the context of the present invention. These and other modifications are contemplated by the inventors and will be readily apparent to those skilled in the art informed by the present disclosure.

It will be appreciated by those skilled in the art that while the inventions described herein are described primarily within the context of text or alphanumeric communications, the inventions are also applicable to voice and video communications. That is, rather than establishing text-based communication sessions between users or between a user and another entity (e.g., a remote server), a voice communication or a video communication may also be established. For example, in the case of the mobile handheld device comprising a mobile telephone, a voice or video messaging service may be employed rather than a text messaging service. Similarly, in the case of a messaging service in which a user has requested a particular file, such as a video or audio file, a server storing such video or audio file may be caused to transmit the requested file to the user's (or another user's) computing device, base station or handheld device. It will be appreciated by those skilled in the art that the system architecture described herein has many varied uses, and that such uses are contemplated by the inventors.

The user interface (UI) disclosed herein advantageously allows a user to juggle multiple conversations or text message sessions (such as interactive text messaging with a plurality of other users). The user interface enables straightforward transitions between different tasks or text sessions by each of the users. In one embodiment each conversation has associated with it a respective button on the user interface.

Table 1 shows exemplary bit definitions for the ACK/NACK field. Note that this signaling can be applied to any type of sent message.

TABLE 1

| Value | Meaning | Comments |
|---|---|---|
| 0h | Null Message | |
| 1h | Acknowledgement (ACK) | Acknowledges last message was |
| | | successfully |
| | | retrieved from the far end |
| | | retrieved from the far end |
| 2h | Negative Acknowledgement | CRC or other error on last |
| | | received message. |
| 03 | Undefined | |

Table 2 shows exemplary definitions for the message type field:

TABLE 2

| Value | Message Type | Comments |
|---|---|---|
| 0h | Null Message | Used if only need to send |
| | | ACK/NACK |
| 1h | Registration Request (RRQ) | Request for Registration. |
| | | Data field holds login |
| | | and password |
| 2h | Registration Rejected (RR) | Registration is rejected. |
| | | Data Field holds error |
| | | codes. |
| 3h | Registration Granted (RG) | Grant Registration since |
| | | network service accepted |
| | | login and password |
| 4h | Buddy List Message (BL) | Data field holds Buddy lists that |
| | | are sent one list at a time. See |
| | | Buddy list format definition for |
| | | how to interpret the data field. |
| 5h | IM Message (IM) | Data field holds IM Message that |
| | | is sent one at a time. See IM |
| | | Message format definition for |
| | | how to interpret the data field. |
| 6h | Buddy Event (BE) | Data field holds identity of buddies |
| | | that have become active or |
| | | inactive. |
| 7h | IM Message Approval (IMA) | Used to signal when an incoming |
| | | message that needs to be approved |
| | | is received. |
| 8h | Approve IM (AIM) | Used to signal acceptance of an |
| | | IMA message |
| 9h | Deny IM (DIM) | Used to deny acceptance of an |
| | | incoming IMA |
| 0ah | Open Chat Window (OCW) | Used to open a window on the |
| | | Wireless device for chatting |
| | | and Iming |
| 0bh | Close Chat Window (CCW) | Used to close a window for |
| | | chatting and IMing. Also releases |
| | | the CHID so it can be reused. |
| 0ch | Deny Chat Window (DCW) | Used by Wireless device to |
| | | indicate all chat windows are in |
| | | use. Used to prevent glare |
| | | condition when both ends try to |
| | | open the last remaining chat |
| | | window at the same time. |
| 0dh | RTX Alert Data | A message that contains RTX file |
| | | information |
| 0eh- | Undefined | |
| 1fh | | |

### EXAMPLE

After user has been authenticated, buddy list information and active buddy states for that user needs to be sent to the wireless device associated with that user. In one embodiment, the messages use the following structure for the data field where the ↑ character represents a value of 0 feh and is used to delimit the data fields:

“List Name↑Buddy 1↑BIDA/IBuddy 2↑BIDA/I . . . Buddy↑N↑BIDA/I”

A buddy identifier (BID) is an identifier that the PC client assigns to that buddy and is an 8-bit integer with a value between 0 and 254. The BID is used in handling subsequent incoming messages and lets the wireless device 148 quickly associate a message with an ongoing session without having to sort through many multi-character names. The wireless device 148 discards any previous association with a buddy name if a BID number is reused by the PC Client in a buddy list message. For example, a buddy list called “Friends” with three names Bill, Joe, and Mike with only Mike being online, would have a data field that looks like this:

“Friends↑Bill↑01hIJoe↑02hIMike↑03hA”

A Buddy Event Message (BE) is a message used to notify the wireless device user as buddies go on and off line. A BE can also be used to sound alerts to the wireless device user to indicate a buddy has come or gone. Preferably, only state changes are sent with these messages, and changes are sent for buddies that have been previously sent to the Wireless device in a Buddy list message. The data field format of a BE is: “BIDA/I↑BIDA/I↑ . . . ” where BID is the BID that was previously used in a buddy list message and the character A or I indicate if the new state is active or inactive.

An Open Chat Window Message (OCW) is a session message from the wireless device that is interpreted by the PC client as a request to open a chat window for the wireless device to display the IM or chat session in. The Open Chat Window Message has the following format for the data field:

“Name_IM_From↑CHID”

A Close Chat Window Message (OCW) is a session message from the wireless device that is interpreted by the PC client as a request to close an open chat window. The Close Chat Window Message has this format for the data field:

“CHID”

A Deny Chat Window Message is a session message from the wireless device that is interpreted by the PC client as a request to deny the PC client the opening of a new window. This is necessary to guard against the event of the wireless device opening the last available chat window when at the same time as the PC Client tries to open a new chat window. The data field for this message is the CHID value of the OCW command received that cannot be opened.

Instant Messages (IM) are communicated using the Instant Message type message. Instant Messages have the following data format:

“N↑Name_IM_To↑ . . . Name_IM_To↑Name_IM_From↑CHIDText of Message”

where N is illustratively between 0 and 9 and is the number of Name_IM_To fields to follow. The message is used to open a messaging session in one window to each of the listed names. The CHID identifies which chat window the message is going to or is from on the wireless device. Once a CHID has been established, it is not necessary for the handheld to resend the to names; the PC client should remember the associated names for this CHID and forward the message to all recipients. For chat sessions that are initiated, the Name_IM_From is the name of the inviter to the chat session. If the total size of the data field is less than, for example, 254 characters, then the IM text may be truncated to meet this limit.

An IM Approval Message (IMA) is an optional administrative message that gives the user the option to accept or reject communication with another user person. The data field for this message has this format:

“Name_IM_From↑Session_Type” This is contemplated to be an administration option the user makes on the PC Client.

Approve IM (AIM) and Deny IM (DIM) Messages are used to indicate the response that a wireless device user makes to the query from the PC Client. These messages have no data field. The PC Client should never have more than one outstanding IM Approval Message at a time.

IM Service Interfaces

The following discussion is directed to identifying the interface process to an IM service, such that a session can be established and maintained.

With respect to the AOL instant messaging service, the interface process may be performed as follows: First, the handheld software opens a chat window on the unit (unless all are occupied, in which case an error message is generated). Next, the handheld sends an IM message to the PC client with the names of all recipients entered into the user interface listed as recipients. The PC client then takes these names and the message and maps it into a chat invitation message that AOL provides. The PC client then sends all returned messages to the appropriate CHID window.

With respect to the Yahoo instant messaging service, the interface process may be performed as follows: First, the handheld software opens a chat window on the unit (unless all are occupied, in this case an error message is generated). Next, the handheld sends an IM message to the PC client with the names of all recipients entered into the user interface listed as recipients. The PC client then takes these names and first sets up an IM session to one of the listed participants. After that is established, using the “Add User” command the rest of the recipients are added one at a time to the chat session. The PC client then sends all returned messages to the same CHID window. Subsequent messages from the handheld are likewise sent out to all recipients.

With respect to the Microsoft instant messaging service, the interface process may be performed as follows: First, the handheld software opens a chat window on the unit (unless all are occupied, in this case an error message is generated). Next, the handheld sends an IM message to the PC client with the names of all recipients entered into the user interface listed as recipients. The PC client then takes these names and first sets up an IM session to one of the listed participants. After that is established, using the “Inivite Someone to this Conversation” command the rest of the recipients are added one at a time to the chat session. The PC client then sends all returned messages from this conversation to the same CHID window. Subsequent messages from the handheld are likewise sent out to all recipients.

Although various embodiments that incorporate the teachings of the present invention have been described herein, those skilled in the art can readily devise many other varied embodiments that still incorporate these teachings.

What is claimed is:

1. A method, comprising:
identifying an IM service associated with a received IM service message;
converting said received instant messaging (IM) service message into an intermediate protocol message; and
forwarding said intermediate protocol message toward a radio frequency (RF) transmitting device.

2. The method of claim 1, further comprising:
transmitting said intermediate protocol message using a radio frequency (RF) transport protocol, said RF transport protocol adapted for use by at least one wireless device.

3. The method of claim 1, further comprising:
repeating said transmitting until an acknowledgement of message reception is received.

4. The method of claim 1, further comprising:
receiving and intermediate protocol message from a user;
converting said received intermediate protocol message into an appropriate IM service message; and
forwarding said intermediate protocol message towards a server associated with said appropriate IM service.

5. The method of claim 4, further comprising:
identifying an IM service associated with said user to determine thereby an appropriate IM service.

6. The method of claim 3, wherein said acknowledgement of message reception is indicated in a status field of said intermediate protocol message.

7. The method of claim 1, further comprising:
determining if any wireless devices adapted to use the intermediate protocol are responsively proximate; and
registering as part of a common group those wireless devices determined to be responsively proximate.

8. The method of claim 1, wherein said intermediate protocol message comprises a data structure including a frame boundary field, a message type field and a data field.

9. The method of claim 8, wherein said data structure further comprises a status field and an error indication field.

10. Messaging system, comprising:
at least one wireless device capable of sending and receiving messages using an intermediate messaging protocol; and
a computing device, for enabling message communication between said wireless device and an instant messenger service, said computing device translating messages between said intermediate messaging protocol and a protocol adapted for use by said instant messenger service.

11. The system of claim 10, further comprising:
a base station, coupled to said computing device, for providing wireless communications with said at least one wireless device to enable said at least one wireless device to communicate with said computing device.

12. The system of claim 11, wherein said base station is included within said computing device.

13. The system of claim 11, wherein said base station is connected to said computing device via a communications link.

14. The system of claim 13, wherein said communications link comprises at least one of a computing device system bus, a universal serial bus (USB), a serial interface, a parallel interface and a network connection.

15. The method of claim 10, wherein said computing device performs messaging protocol translation functions and said base station performs RF transport processing functions.

16. Apparatus, comprising:
a plurality of first modules, for routing messages received from respective instant messaging (IM) services to a second module, said second module converting each routed message into an intermediate protocol message adapted for subsequent radio frequency (RF) transmission to a user.

17. The apparatus of claim 16, further comprising:
a base module, for transmitting said routed and converted intermediate protocol messages to appropriate users.

18. The apparatus of claim 17, further comprising:
at least one wireless device, for responsively processing intermediate protocol messages transmitted by said base station if said wireless device is associated with an intended recipient.

19. The apparatus of claim 16, wherein said first modules comprise service specific gateway modules and said second module comprises a normalization and conversion module.

20. Apparatus for providing instant messaging communications available from a service provider to a plurality of wireless mobile devices, comprising:
a base station computer device (BSCD) having connectivity to said service provider providing said instant messaging communications;
a base station coupled to said BSCD, said base station receiving said instant messaging communications from said BSCD and communicating said instant messaging communications to at least one of said plurality of wireless mobile devices in response to a command to send said instant messaging communications.

21. The apparatus of claim 20, wherein said base station computer device is selected from a group of computing devices consisting of a desktop computer, a laptop computer, a workstation, and a file server.

22. The apparatus of claim 20, wherein said BSCD is coupled to said service provider via the Internet.

23. The apparatus of claim 20, wherein said BSCD comprises a wireless instant messaging managing program, said managing program operating in conjunction with an operating system installed on said BSCD.

24. The apparatus of claim 20, wherein said wireless instant messaging managing program automatically connects said BSCD to said service provider in response to a login command by one of said plurality of wireless mobile devices.

25. The apparatus of claim 24, wherein said wireless instant messaging managing program provides services selected from the group consisting of instant messaging, chat rooms, lists of names, programmable alerts, away messages, login/logout features, invitations to join chat rooms, emoticon translation, edit/import RTX files, registration mobile devices, dial-up networking, and accept/reject name list invitations, password protection.

26. The apparatus of claim 20, wherein said base station is coupled to said BSCD via USB cabling.

27. The apparatus of claim 20, wherein said base station accommodates recharging of said mobile devices.

28. The apparatus of claim 20, wherein each said wireless mobile device comprises:
a processor
a keyboard for typing characters;
a display for viewing said typed characters and communications received by said wireless mobile device
